(19) United States
(12) Patent Application Publication
(10) Pub. No.: US 2023/0186446 A1
(43) Pub. Date: Jun. 15, 2023

(54) IMAGE PROCESSING METHODS AND SYSTEMS FOR LOW-LIGHT IMAGE ENHANCEMENT USING MACHINE LEARNING MODELS

(71) Applicant: 7 SENSING SOFTWARE, Paris (FR)

(72) Inventors: Clément René MARTI, Malakoff (FR); Elnaz SOLEIMANI, Paris (FR); Arnaud COLLARD, Montesson (FR); Oleksandr BOIKO, Vincennes (FR)

(21) Appl. No.: 17/551,930

(22) Filed: Dec. 15, 2021

(51) Int. Cl. G06T 5/50; G06V 10/774; G06N 3/04

(52) U.S. Cl. CPC G06T 5/50; G06V 10/7747; G06N 3/04

(57) ABSTRACT

The present disclosure relates to an image processing method for enhancing illumination in an input image representing a scene, said image processing method comprising:
down-sampling the input image,
processing the down-sampled input image with a machine learning model, wherein said machine learning model is previously trained to generate a multiplicative correction map, said multiplicative correction map comprising multiplicative correcting factors for enhancing the illumination of the down-sampled input image,
up-sampling the multiplicative correction map,
generating an output image by multiplying the input image by the up-sampled multiplicative correction map.

### TECHNICAL FIELD

The present disclosure relates to image processing and relates more specifically to methods and computing systems for low-light image enhancement using machine learning models.

### BACKGROUND ART

In image processing, low-light image enhancement relates to the processing applied to enhance the illumination of images captured in an insufficiently illuminated environment.

In the prior art, machine learning models have been proposed for enhancing the illumination of low-light images.

In particular, some prior art methods are based on supervised learning and use a training dataset containing paired images. Basically, each pair of images comprises a low-light input image and a target output image which corresponds to an illumination enhanced version of the low-light image. Training the machine learning model based on such pairs then corresponds to training the machine learning model to enable predicting the target image from the associated low-light image of the considered pair.

In practice, each target image/low-light image pair should represent the exact same scene under different illumination conditions.

This can be simple to achieve in the case of static images, by e.g. having a static camera imaging a same scene under different illumination conditions (e.g. at different times of day and night).

However, in some cases, it might be useful to have image sequence (i.e. video) pairs, and it is very difficult to capture videos of the exact same scene under different illumination conditions, especially when the camera capturing the video is moving with respect to the scene.

Indeed, an additional issue with low-light image sequences is that the illumination enhancement needs to be performed while maintaining a temporal consistency between successive images of the sequence, to avoid e.g. illumination fluctuations in the output image sequence. Temporal consistency of the output image sequence can be improved by training the machine learning model with target image sequence/low-light image sequence pairs. Hence, there is a need for training datasets containing a large number target image sequence/low-light image sequence pairs, which remains a challenging task.

[Jiang+2019] proposes using two cameras, one of which has a darkening filter, to acquire two image sequences (videos) at the same time. In [Jiang+2019], the two cameras share a common optical system to have exactly the same position and motion. However, the image sequence acquired by the camera with the darkening filter is not really a low-light image-sequence. While this image sequence is indeed darker, the contrast of objects is very different from a real low-light image sequence. Also, the darkening filter reduces the light from sources of light, while in real low-light image sequences the sources of light are very bright and the shadows are very dark, so the contrast is very high. This cannot be achieved with a darkening filter. The US patent application US 2020/0051217 A1 proposes a similar solution.

[Lv+2020] proposes taking one image sequence in well-lit conditions, and to pass it through a darkening function to create a synthetic (i.e. virtual) low-light image sequence. Such a solution enables to obtain two image sequences representing the same scene with the same motion of the camera with respect to the scene, under different illumination conditions. However, the quality of the training and of the achievable perceived quality of the illumination enhancement depends heavily on the capacity of the darkening function to produce realistic low-light image sequences.

Also, when enhancing the illumination of a low-light image sequence, the goal is usually to produce an image sequence having a “night” look and not an image sequence representing the scene in well-lit conditions. Hence, well-lit image sequences are not necessarily optimal ground-truth data in the context of low-light image sequence enhancement.

Another limitation of the prior art solutions lies in the fact that the machine learning models proposed for low-light image enhancement are usually computationally expensive, and are difficult to use with devices having constrained computational and data storage capabilities, for instance mobile devices such as mobile phones, tablets, digital cameras, etc.

### SUMMARY

The present disclosure aims at improving the situation. In particular, the present disclosure aims at overcoming at least some of the limitations of the prior art discussed above.

In some embodiments, the present disclosure aims at proposing a solution for training a machine learning model based on target image/low-light image pairs which uses an improved darkening process in order to produce more realistic synthetic low-light images. Also, the present disclosure aims at proposing a solution which, in some embodiments, sets constrains on the target images in order to produce more realistic synthetic low-light images.

In some embodiments, the present disclosure aims at proposing a solution for enhancing the illumination of input images by using a machine learning model which can be implemented with limited computational complexity and may be used even by devices having constrained computational and data storage capabilities.

For this purpose, and according to a first aspect, the present disclosure relates to an image processing method for generating a training dataset for training a machine learning model to enhance illumination of input images, said training dataset comprising target image/low-light image pairs to be used to train the machine learning model, said image processing method comprising, for generating a target image/low-light image pair:
obtaining a target image representing a scene in a first color space, said first color space comprising a plurality of color channels including a color channel representative of the brightness of the scene, referred to as brightness channel, wherein the first color space comprises two color channels independent of the brightness of the scene, or is the L*a*b* color space,
applying a darkening function to the brightness channel of the target image, thereby obtaining a low-light image of the scene and the target image/low light image pair in the first color space.

Hence, in the present disclosure, the darkening function is applied in a first color space which comprises a color channel representative of the brightness of the scene. The first color space either comprises two other color channels independent of the brightness of the scene or is the L*a*b* color space (a.k.a. CIELAB). In the color spaces used in the prior art (i.e. RGB and YCbCr color spaces), the color and brightness are not well separated, so when the darkening function strongly modifies the Y channel in a YCbCr color space for instance, it can create color artefacts because the Cb and Cr channels also depend on the brightness. In contrast, the present disclosures uses color spaces in which the color channels other than the brightness channel are independent of the brightness of the scene such that color artefacts are significantly reduced when applying a darkening function. The L*a*b* color space (in which the L* channel corresponds to the brightness channel) has also proved to provide separation between color and brightness sufficient enough to yield good darkening results.

It is emphasized that the present disclosure aims at generating target image/low-light image pairs which may correspond to either single images (i.e. the pair comprises a single target image and a single low-light image) or to image sequences/videos (i.e. the pair comprises a target image sequence and a low-light image sequence). Also, by “low-light” image, we mean that the illumination in the low-light image is lower than the illumination in the associated target image since the general goal is to produce brighter versions of low-light input images.

In specific embodiments, the image processing method may further comprise one or more of the following optional features, considered either alone or in any technically possible combination.

In specific embodiments, the first color space is a cylindrical color space. Indeed, cylindrical color spaces are examples of color spaces which comprise a brightness channel and two other color channels independent of the brightness of the scene.

In specific embodiments, the target image represents a scene imaged during twilight or a scene with no sky.

In specific embodiments, the target image represents a scene comprising at least one artificial source of light and imaged with the at least one artificial source of light turned on.

In specific embodiments, the brightness channel values are defined between a minimum value and a maximum value, and the darkening function is such that:
a brightness channel value equal to the maximum value is unchanged by the darkening function,
a brightness channel value equal to the minimum value is unchanged by the darkening function.

Hence, fully black pixels remain black and fully white pixels remain white, which is important to avoid creating color artefacts.

In specific embodiments, the darkening function comprises a weighted sum of at least [V′_{NL}(x,y)]^{β} and [V′_{NL}(x,y)]^{γ}, wherein:

V′_{NL}(x,y)=(V_{NL}(x,y)−Vₘᵢₙ)/(Vₘₐₓ−Vₘᵢₙ),
V_{NL}(x,y) corresponds to the brightness channel value of the pixel (x,y) of the target image,
Vₘₐₓ and Vₘᵢₙ correspond respectively to the maximum value and the minimum value of the brightness channel,
γ corresponds to a positive coefficient with γ>1, and
β corresponds to a positive coefficient with 0<β<γ, or preferably 0<β≤1.

In the context of image processing, [⋅]^{γ} is also known as gamma function and is proposed in [Lv+2020] for the darkening function. However, when selecting a high value for the coefficient γ, the gamma function increases the contrast for high light levels, which is good to represent the separation between strong sources of light and the rest of the scene in low-light conditions. However, the contrast for low light levels becomes near zero, which is bad since it means the shadows become uniform with no detail inside them. Hence by considering a darkening function with an additional term [⋅]^{β} with 0<β<γ (preferably with β=1), the contrast is improved for low light levels by ensuring that it is not almost zero as with the gamma function considered alone.

In specific embodiments, the darkening function is given by: V_{LL}(x,y)=(α×[V′_{NL}(x,y)]^{β}+(1−α)×[V′_{NL}(x,y)]^{γ})×(Vₘₐₓ−Vₘᵢₙ)+Vₘᵢₙ wherein V_{LL}(x,y) corresponds to the brightness channel value of the pixel (x,y) of the low-light image and a corresponds to a positive coefficient with α<1, or preferably α≤0.5.

In specific embodiments, the coefficients α and/or γ are selected randomly for each target image/low-light image pair.

In specific embodiments, the coefficient α is selected randomly according to a probability distribution with a mean value in [0.1; 0.3] and/or the coefficient γ is selected randomly according to a probability distribution with a mean value in [2; 6].

In specific embodiments, obtaining the target image in the first color space comprises:
obtaining the target image representing the scene in a second color space different from the first color space, and
converting the target image from the second color space to the first color space.

In specific embodiments, the image processing method comprises:
converting the low-light image of the scene into a third color space different from the first color space,
responsive to the first color space (and, if applicable, the second color space) being different from the third color space, converting the target image to the third color space.

In specific embodiments, the image processing method further comprises using the training dataset to train the machine learning model to enable predicting the target image of each pair when applied to the low-light image of said each pair.

According to a second aspect, the present disclosure relates to an image processing system for generating a training dataset for training a machine learning model to enhance illumination of input images, said training dataset comprising target image/low-light image pairs to be used to train the machine learning model, said image processing system comprising a dataset generating unit comprising at least one memory and at least one processor, wherein said at least one processor of the dataset generating unit is configured to generate a target image/low-light image pair by:
obtaining a target image representing a scene in a first color space, said first color space comprising a plurality of color channels including a color channel representative of the brightness of the scene, referred to as brightness channel, wherein the first color space comprises two color channels independent of the brightness of the scene, or is the L*a*b* color space,
applying a darkening function to the brightness channel of the target image, thereby obtaining a low-light image of the scene and the target image/low light image pair in the first color space.

In specific embodiments, the image processing system may further comprise one or more of the following optional features, considered either alone or in any technically possible combination.

In specific embodiments, the first color space is a cylindrical color space.

In specific embodiments, the target image represents a scene imaged during twilight or a scene with no sky.

In specific embodiments, the target image represents a scene comprising at least one artificial source of light and imaged with the at least one artificial source of light turned on.

In specific embodiments, the brightness channel values are defined between a minimum value and a maximum value, and the darkening function is such that:
a brightness channel value equal to the maximum value is unchanged by the darkening function,
a brightness channel value equal to the minimum value is unchanged by the darkening function.

In specific embodiments, the darkening function comprises a weighted sum of at least [V′_{NL}(x,y)]^{β} and [V′_{NL}(x,y)]^{γ}, wherein:

V′_{NL}(x,y)=(V_{NL}(x,y)−Vₘᵢₙ)/(Vₘₐₓ−Vₘᵢₙ),
V_{NL}(x,y) corresponds to the brightness channel value of the pixel (x,y) of the target image,
Vₘₐₓ and Vₘᵢₙ, correspond respectively to the maximum value and the minimum value of the brightness channel,
γ corresponds to a positive coefficient with γ>1, and
β corresponds to a positive coefficient with 0<β<γ, or preferably 0<β≤1.

In specific embodiments, the darkening function is given by: V_{LL}(x,y)=(α×[V′_{NL}(x,y)]^{β}+(1−α)×[V′_{NL}(x,y)]^{γ})×(Vₘₐₓ−Vₘᵢₙ)+Vₘᵢₙ wherein V_{LL}(x,y) corresponds to the luminance channel value of the pixel (x,y) of the low-light image and a corresponds to a positive coefficient with α<1, or preferably α≤0.5.

In specific embodiments, the coefficients α and/or γ are selected randomly for each target image/low-light image pair.

In specific embodiments, the coefficient α is selected randomly according to a probability distribution with a mean value in [0.1; 0.3] and/or the coefficient γ is selected randomly according to a probability distribution with a mean value in [2; 6].

In specific embodiments, the at least one processor of the dataset generating unit is configured to obtain the target image in the first color space by:
obtaining the target image representing the scene in a second color space different from the first color space, and
converting the target image from the second color space to the first color space.

In specific embodiments, the at least one processor of the dataset generating unit is further configured to:
convert the low-light image of the scene into a third color space different from the first color space,
responsive to the first color space being different from the third color space, convert the target image to the third color space.

In specific embodiments, the image processing system further comprises a training unit comprising at least one memory and at least one processor, wherein said at least one processor of the training unit is configured to use the training dataset to train the machine learning model to enable predicting the target image of each pair when applied to the low-light image of said each pair.

According to a third aspect, the present disclosure relates to a non-transitory computer readable medium comprising computer readable code which, when executed by one or more processors, cause said one or more processors to generate a training dataset for training a machine learning model to enhance illumination of input images, said training dataset comprising target image/low-light image pairs to be used to train the machine learning model, wherein said computer readable code causes said one or more processors to generate a target image/low-light image pair by:
obtaining a target image representing a scene in a first color space, said first color space comprising a plurality of color channels including a color channel representative of the brightness of the scene, referred to as brightness channel, wherein the first color space comprises two color channels independent of the brightness of the scene, or is the L*a*b* color space,
applying a darkening function to the brightness channel of the target image, thereby obtaining a low-light image of the scene and the target image/low light image pair in the first color space.

According to a fourth aspect, the present disclosure relates to an image processing method for enhancing illumination in an input image representing a scene, said image processing method comprising:
down-sampling the input image,
processing the down-sampled input image with a machine learning model, wherein said machine learning model is previously trained to generate a multiplicative correction map, said multiplicative correction map comprising multiplicative correcting factors for enhancing the illumination of the down-sampled input image,
up-sampling the multiplicative correction map,
generating an output image by multiplying the input image by the up-sampled multiplicative correction map.

Hence, the machine learning model is applied on a down-sampled input image, which reduces the computational complexity and the memory footprint for using the trained machine learning model. Thanks to the fact that the predicted correction map is a multiplicative one, the contrast is not degraded despite performing part of the processing at a lower resolution.

In specific embodiments, the illumination enhancement image processing method may further comprise one or more of the following optional features, considered either alone or in any technically possible combination.

In specific embodiments, the machine learning model is a convolutional neural network or comprises a U-Net.

In specific embodiments, the input image comprises pixels, each pixel comprising color channel values in respective color channel ranges, each color channel range comprising a respective maximum value. Responsive to identifying a saturated pixel of the input image for which a color channel value is equal to the maximum value of the corresponding color channel range, the saturated pixel is copied in the output image without applying the up-sampled multiplicative correction map to said saturated pixel.

In specific embodiments, the illumination enhancement image processing method comprises adding an offset value to pixels of the input image before multiplying the input image by the up-sampled multiplicative correction map values to generate the output image.

In specific embodiments, each pixel of the input image comprises color channel values in respective color channel ranges, each color channel range comprising a respective maximum value. Responsive to identifying a saturated pixel of the input image obtained after adding the offset value for which a color channel value is equal to the maximum value of the corresponding color channel range, the saturated pixel is copied in the output image without applying the up-sampled multiplicative correction map to said saturated pixel.

In specific embodiments, each pixel of the input image comprises color channel values in respective color channel ranges, each color channel range comprising a respective maximum value. Responsive to identifying a saturated pixel of the input image before adding the offset value for which a color channel value is equal to the maximum value of the corresponding color channel range, the saturated pixel is copied in the output image without adding the offset value and without applying the up-sampled multiplicative correction map to said saturated pixel.

According to a fifth aspect, the present disclosure relates to an image processing system for enhancing illumination in an input image representing a scene, said image processing system comprising a correcting unit comprising at least one memory and at least one processor, wherein said at least one processor of the correcting unit is configured to:
down-sample the input image,
process the down-sampled input image with a machine learning model, wherein said machine learning model is previously trained to generate a multiplicative correction map, said multiplicative correction map comprising multiplicative correcting factors for enhancing the illumination of the down-sampled input image,
up-sample the multiplicative correction map,
generate an output image by multiplying the input image by the up-sampled multiplicative correction map.

In specific embodiments, the illumination enhancement image processing system may further comprise one or more of the following optional features, considered either alone or in any technically possible combination.

In specific embodiments, the machine learning model is a convolutional neural network or comprises a U-Net.

In specific embodiments, each pixel comprises color channel values in respective color channel ranges, each color channel range comprising a respective maximum value. The at least one processor of the correcting unit is further configured to, responsive to identifying a saturated pixel of the input image for which a color channel value is equal to the maximum value of the corresponding color channel range, copy the saturated pixel in the output image without applying the up-sampled multiplicative correction map to said saturated pixel.

In specific embodiments, the at least one processor of the correcting unit is further configured to add an offset value to pixels of the input image before multiplying the input image by the up-sampled multiplicative correction map values to generate the output image.

In specific embodiments, each pixel of the input image comprises color channel values in respective color channel ranges, each color channel range comprising a respective maximum value. The at least one processor of the correcting unit is further configured to, responsive to identifying a saturated pixel of the input image obtained after adding the offset value for which a color channel value is equal to the maximum value of the corresponding color channel range, copy the saturated pixel in the output image without applying the up-sampled multiplicative correction map to said saturated pixel.

In specific embodiments, each pixel of the input image comprises color channel values in respective color channel ranges, each color channel range comprising a respective maximum value. The at least one processor of the correcting unit is further configured to, responsive to identifying a saturated pixel of the input image before adding the offset value for which a color channel value is equal to the maximum value of the corresponding color channel range, copy the saturated pixel in the output image without adding the offset value and without applying the up-sampled multiplicative correction map to said saturated pixel.

According to a sixth aspect, the present disclosure relates to a non-transitory computer readable medium comprising computer readable code which, when executed by one or more processors, cause said one or more processors to enhance illumination in an input image representing a scene by:
down-sampling the input image,
processing the down-sampled input image with a machine learning model, wherein said machine learning model is previously trained to generate a multiplicative correction map, said multiplicative correction map comprising multiplicative correcting factors for enhancing the illumination of the down-sampled input image,
up-sampling the multiplicative correction map,
generating an output image by multiplying the input image by the up-sampled multiplicative correction map.

### BRIEF DESCRIPTION OF DRAWINGS

The invention will be better understood upon reading the following description, given as an example that is in no way limiting, and made in reference to the figures which show:

FIG. 1: a diagram representing the main phases of supervised learning for a machine learning model,

FIG. 2: a schematic representation of an exemplary embodiment of a dataset generating unit,

FIG. 3: a schematic representation of an exemplary embodiment of a training unit,

FIG. 4: a schematic representation of an exemplary embodiment of a correcting unit,

FIG. 5: a diagram representing the main steps of an exemplary embodiment of an image processing method for generating a training dataset for low-light image illumination enhancement,

FIG. 6: diagrams representing the main steps of exemplary embodiments of the image processing method of FIG. 5,

FIG. 7: a diagram representing the main steps of an exemplary embodiment of an image processing method for enhancing the illumination of an input image using a machine learning model,

FIG. 8: a diagram representing the main steps of an exemplary embodiment of a training phase of the machine learning model used in the illumination enhancement image processing method.

In these figures, references identical from one figure to another designate identical or analogous elements. For reasons of clarity, the elements shown are not to scale, unless explicitly stated otherwise.

Also, the order of steps represented in these figures is provided only for illustration purposes and is not meant to limit the present disclosure which may be applied with the same steps executed in a different order.

### DESCRIPTION OF EMBODIMENTS

As indicated above, the present disclosure relates inter alia to an image processing method and system for low-light image enhancement using a machine learning model. Low-light image enhancement corresponds to selectively increase the brightness in an image (i.e. a single image or an image sequence) captured under low-light conditions.

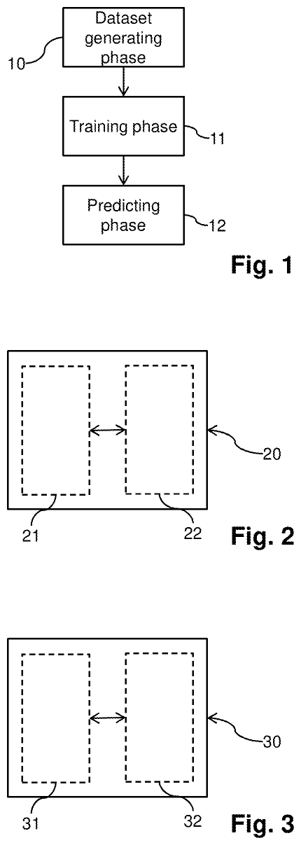

The machine learning model is preferably trained via supervised learning. It is well known that, in such a case, the machine learning model undergoes mainly two different phases, as represented in FIG. 1, namely:
a training phase 11 during which the machine learning model is trained by using a training dataset,
a predicting phase 12 during which the trained machine learning model is then applied to input images for which low-light enhancement is requested.

As illustrated by FIG. 1, the training dataset can be generated during a dataset generating phase 10 and used during the training phase 11.

It is emphasized that the dataset generating phase 10, the training phase 11 and the predicting phase 12 can be executed separately, independently from one another, the training phase 11 receiving as input the training dataset generated during the dataset generating phase 10 and the predicting phase 12 receiving as input the machine learning model trained during the training phase 11. For instance, the dataset generating phase 10 may be executed by a dataset generating unit 20, the training phase 11 may be executed by a training unit 30 and the predicting phase 12 may be executed by a correcting unit 40. The dataset generating unit 20, the training unit 30 and the correcting unit 40 may be all separate, i.e. they may be embedded in respective separate computing systems, or two or more of the dataset generating unit 20, the training unit 30 and the correcting unit 40 may be embedded in a same computing system (in which case they can share hardware resources such as processors, memories, etc.). In the present disclosure, an image processing system may comprise at least one among the dataset generating unit 20, the training unit 30 and the correcting unit 40, and an image processing method may comprise at least one among the dataset generating phase 10, the training phase 11 and the predicting phase 12

FIG. 2 represents schematically an exemplary embodiment of a dataset generating unit 20. As illustrated by FIG. 2, the dataset generating unit 20 comprises one or more processors 21 and one or more memories 22. The one or more processors 21 may include for instance a central processing unit (CPU), a graphics processing unit (GPU), a neural processing unit (NPU), a digital signal processor (DSP), a field-programmable gate array (FPGA), an application specific integrated circuit (ASIC), etc. The one or more memories 22 may include any type of computer readable volatile and non-volatile memories (magnetic hard disk, solid-state disk, optical disk, electronic memory, etc.). The one or more memories 22 may store a computer program product, in the form of a set of program-code instructions to be executed by the one or more processors 21 in order to implement all or part of the steps of the dataset generating phase 10. Once the training dataset has been generated, it can be stored in the one or more memories 22 and/or it can be stored in a remote database (not shown in the figures) and/or it can be sent to the training unit 30.

FIG. 3 represents schematically an exemplary embodiment of a training unit 30. As illustrated by FIG. 3, the training unit 30 comprises one or more processors 31 and one or more memories 32. The one or more processors 31 may include for instance a CPU, a GPU, a NPU, a DSP, an FPGA, an ASIC, etc. The one or more memories 32 may include any type of computer readable volatile and non-volatile memories (magnetic hard disk, solid-state disk, optical disk, electronic memory, etc.). The one or more memories 32 may store a computer program product, in the form of a set of program-code instructions to be executed by the one or more processors 31 in order to implement all or part of the steps of the training phase 11 of the machine learning model used for color correction. For instance, the training dataset may be stored in the one or more memories 32 after it has been retrieved from e.g. a remote database or directly from the dataset generating unit 20. Once the machine learning model has been trained, it can be stored in the one or more memories 32 and/or it can be stored in a remote database (not shown in the figures) and/or it can be sent to the correcting unit 40.

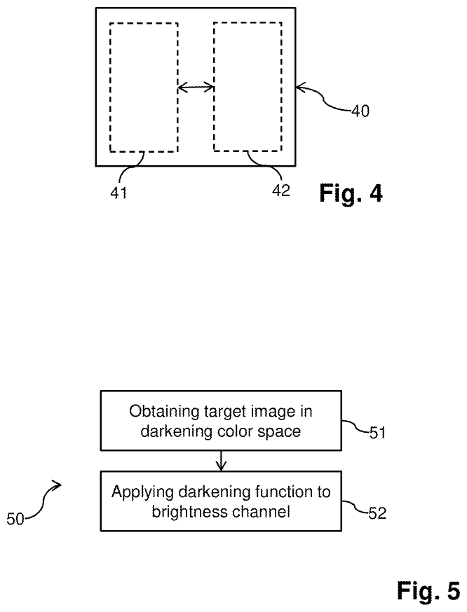

FIG. 4 represents schematically an exemplary embodiment of a correcting unit 40. As illustrated by FIG. 4, the correcting unit 40 comprises one or more processors 41 and one or more memories 42. The one or more processors 41 may include for instance a CPU, a GPU, a NPU, a DSP, a FPGA, an ASIC, etc. The one or more memories 42 may include any type of computer readable volatile and non-volatile memories (magnetic hard disk, solid-state disk, optical disk, electronic memory, etc.). The one or more memories 42 may store a computer program product, in the form of a set of program-code instructions to be executed by the one or more processors 41 in order to enhance illumination of an input image by using a trained machine learning model. For instance, the trained machine learning model may be stored in the one or more memories 42 of the correcting unit 40 after it has been retrieved from e.g. a remote database or directly from the training unit 30.

FIG. 5 represents schematically the main steps of an image processing method 50 for generating a training dataset, to be used to train a machine learning model used for low-light image enhancement, which main steps are carried out by the dataset generating unit 20.

As discussed above, the training dataset comprises target image/low-light image pairs. For the training phase 11, the target image of a pair corresponds to the reference data (a.k.a. “ground truth” data) representative of the expected brighter version of the low-light image of said pair, to be obtained when using the machine learning model.

Also, the target image/low-light image pairs may correspond to either single images (i.e. the pair comprises a single target image and a single low-light image) or to image sequences/videos (i.e. the pair comprises a target image sequence and a low-light image sequence).

As illustrated by FIG. 5, the image processing method 50 comprises a step 51 of obtaining an image representing a scene in a first color space, referred to as darkening color space, said image referred to as target image. Said darkening color space comprises a plurality of color channels, usually three color channels. One of the color channels of the darkening color space is representative of the brightness of the scene and is referred to as brightness channel. Preferably, the darkening color space comprises also two other color channels which are independent of the brightness of the scene, such that the values of said two other color channels do not depend on the value of the brightness channel. Alternatively, the darkening color space may comprise two other color channels which are not completely independent from the brightness of the scene but provide a good separation between color and brightness.

Color spaces comprising a brightness channel and two color channels independent from the brightness of the scene are therefore such that when increasing the brightness of a scene, only the brightness channel is affected. Non-limitative examples of such color spaces comprising a brightness channel and two other color channels independent from the brightness of the scene include the cylindrical color spaces, a.k.a. hue-chroma-luminance color spaces wherein hue represents the tint of a color, chroma represents whether the color is close to a gray or is a vivid color, and luminance represents the brightness of the color. Examples of cylindrical color spaces which may be used in the present disclosure include:
the HSV color space for which the color channels are the hue H, saturation S and value V channels, wherein the brightness channel corresponds to the V channel,
the HSL color space for which the color channels are the hue H, saturation S and luminance L channels, wherein the brightness channel corresponds to the L channel,
the HSI color space for which the color channels are the hue H, saturation S and intensity I channels, wherein the brightness channel corresponds to the I channel,
the LC*h*(uv) color space (which is the cylindrical version of the L*u*v* color space, a.k.a. CIE 1976 L*u*v*) for which the color channels are the lightness L*, chroma C*uv and hue h*uv channels, wherein the brightness channel corresponds to the L* channel,
the L*C*h color space (which is the cylindrical version of the L*a*b* color space, a.k.a. CIE 1976 L*a*b* or CIELAB) for which the color channels are the lightness L*, chroma C* and hue h channels, wherein the brightness channel corresponds to the L* channel.

Examples of (non-cylindrical) color spaces comprising a brightness channel and two color channels independent from the brightness of the scene, which may be used in the present disclosure, include:
the xyY color space, a.k.a CIE xyY, for which the color channels are the x,y and Y channels, wherein the brightness channel corresponds to the Y channel,
a color space derived from the L*a*b* color space, but using as color channels L*, a*/L* and b*/L*, wherein the brightness channel corresponds to the L* channel, and the other two color channels are independent from the brightness of the scene.

Also, the inventors have found that the L*a*b* color space, although not having two color channels strictly independent from the brightness of the scene, provided a separation between color and brightness sufficient enough to yield good darkening results. When considering the L*a*b* color space, the brightness channel corresponds to the L* channel.

Also, the image processing method 50 comprises a step 52 of applying a darkening function to the brightness channel of the target image, thereby obtaining a synthetic (virtual) low-light image of the scene and the target image/low light image pair in the darkening color space. The darkening function aims at reducing the brightness of the target image, and the low-light image is therefore a version of the target image in which the brightness has been reduced.

In the darkening color space, the color and luminance are much better separated, which is particularly advantageous when applying a darkening function. In particular, it reduces color artefacts compared to applying the darkening function in other color spaces such as e.g. the conventional RGB (red-green-blue) or YCbCr color spaces. Another advantage is that the darkening function needs only to be applied to a single color channel in the darkening color space, i.e. the brightness channel of the darkening color space.

It should be noted that other color spaces may be involved during the image processing method 50. For instance, the target image may be initially obtained or acquired in a second color space, referred to as acquisition color space, which may be different from the darkening color space. Also, the target image/low-light image pairs may need to be converted into a third color space, referred to as processing color space, which may be different from the darkening color space and which may correspond for instance to the color space in which the training of the machine learning model is to be performed and/or the color space in which the machine learning model is to be applied for illumination enhancement of images. The acquisition color space and the processing color space may be the same or different color spaces.

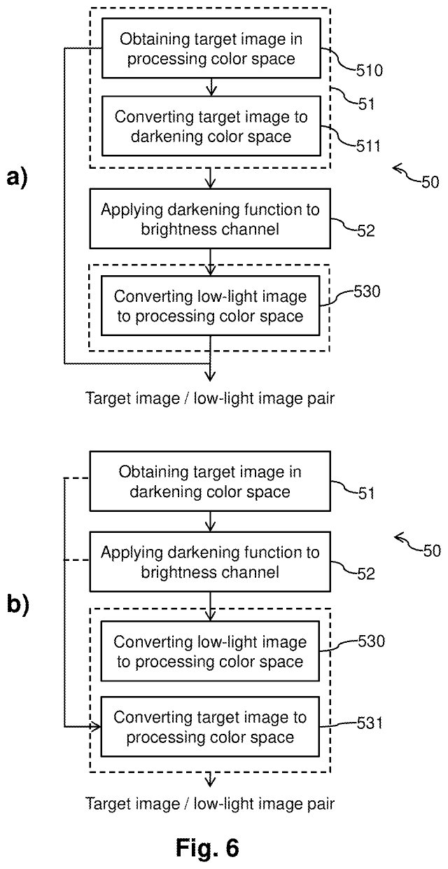

FIG. 6 represents schematically exemplary embodiments of the image processing method 50 in the case where the machine learning model is to be applied for low-light enhancement of images in a processing color space different from the darkening color space.

As illustrated by FIG. 6, the image processing method 50 comprises a step 530 of converting the low-light image of the scene from the darkening color space to the processing color space. For instance, the darkening color space corresponds to the HSV color space and the processing color space corresponds to the RGB color space, in which case step 530 corresponds to a HSV/RGB color space conversion.

Part a) of FIG. 6 represents an embodiment in which the acquisition color space of the target image is different from the darkening color space but is identical to the processing color space. As illustrated by part a) of FIG. 6, the step 51 of obtaining the target image in the darkening color space comprises for instance:
a step 510 of acquiring a target image representing a scene in the processing color space, and
a step 511 of converting the target image from the processing color space to the darkening color space, thereby obtaining the target image of the scene in the darkening color space; for instance, the darkening color space corresponds to the HSV color space and the processing and acquisition color spaces correspond to the RGB color space, in which case step 511 corresponds to a RGB/HSV color space conversion.

In the example illustrated by part a) of FIG. 6, the target image/low-light image pair included in the training dataset corresponds to the pair composed of the target and low-light images in the processing color space.

Part b) of FIG. 6 represents another embodiment in which no version of the target image exists in the processing color space (either because the target image has been acquired directly in the darkening color space or has been obtained from a target image captured in an acquisition color space different from both the processing and darkening color spaces). As illustrated by part b) of FIG. 6, the image processing method 50 further comprises a step 531 of converting the target image from the darkening color space (or the acquisition color space) into the processing color space. The target image/low-light image pair included in the training dataset corresponds to the pair composed of the target and low-light images in the processing color space.

In the sequel, we assume in a non-limitative manner that the darkening color space corresponds to the HSV color space. In the HSV color space, the brightness channel corresponds to the V (value) channel, while the other two color channels correspond to the H (hue) and S (saturation) channels. Of course, the embodiments described hereinbelow assuming that the darkening color space is the HSV color space can be applied similarly to any of the darkening color spaces discussed above, by considering the corresponding brightness channel instead of the V channel. In the sequel, the target image, and the low-light image in the (HSV) darkening color space are referred to as respectively target HSV image and low-light HSV image.

In the sequel, the target HSV image and the low-light HSV image are assumed in a non-limitative manner to have a size W×H×Ch, wherein:
W corresponds to a number of pixels along a width dimension,
H corresponds to a number of pixels along a height dimension,
Ch corresponds to a number of color channels, i.e. Ch=3 for the HSV color space in which the color channels correspond to the H (hue), S (saturation) and V (value) channels.

The target HSV image is denoted by NL_{HSV} in the sequel and is composed of W×H pixels. The value NL_{HSV}(x,y) of a given pixel (x,y) (with 1≤x≤W and 1≤y≤H) corresponds to a vector of size Ch representing an HSV triplet:

NL_{HSV}(x,y)=(H_{NL}(x,y),S_{NL}(x,y),V_{NL}(x,y))

wherein:
H_{NL}(x,y) corresponds to the H channel value for the pixel (x,y),
S_{NL}(x,y) corresponds to the S channel value for the pixel (x,y),
V_{NL}(x,y) corresponds to the V channel value for the pixel (x,y).

Similarly, the low-light HSV image is denoted by LL_{HSV} in the sequel and is composed of W×H pixels. The value LL_{HSV}(x,y) of a given pixel (x,y) (with 1≤x≤W and 1≤y≤H) corresponds to a vector of size Ch representing an HSV triplet:

LL_{HSV}(x,y)=(H_{LL}(x,y),S_{LL}(x,y),V_{LL}(x,y))

wherein:
H_{LL}(x,y) corresponds to the H channel value for the pixel (x,y),
S_{LL}(x,y) corresponds to the S channel value for the pixel (x,y),
V_{LL}(x,y) corresponds to the V channel value for the pixel (x,y).

In the present disclosure, the low-light HSV image is obtained by applying a darkening function to the target HSV image. Due to the good separation between color and luminance in the HSV color space, the darkening function, denoted D_{F} in the sequel, may be applied only on the V channel value, leaving the H channel and S channel values unchanged:

H_{LL}(x,y)=H_{NL}(x,y)

S_{LL}(x,y)=S_{NL}(x,y)

V_{LL}(x,y)=D_{F}(V_{NL}(x,y))

The darkening function D_{F} aims at reducing the illumination of the target HSV image, to produce a synthetic (virtual) low-light HSV image.

Different types of darkening functions may be used in the present disclosure and the choice of a specific type of darkening function corresponds to a specific non-limitative embodiment of the present disclosure.

The V channel values are defined between a minimum value Vₘᵢₙ and a maximum value Vₘₐₓ. In the HSV color space, the V channel value is usually in [0; 1], in which case the maximum value Vₘₐₓ is equal to 1 and the minimum value Vₘᵢₙ is equal to 0.

In specific embodiments, the darkening function D_{F} is such that:
a V channel value equal to the maximum value Vₘₐₓ is unchanged by the darkening function D_{F},
a V channel value equal to the minimum value Vₘₘ is unchanged by the darkening function D_{F}.

Ensuring that the maximum value Vₘₐₓ and the minimum value Vₘᵢₙ of the V channel remain unchanged ensures that the V channel range is fully used and not contracted by the darkening function D_{F}. This also ensures that light sources visible in the target image remain bright.

Alternatively, or in combination thereof, the darkening function D_{F} comprises preferably a weighted sum of at least [V′_{NL}(x,y)]^{β} and [V′_{NL}(x,y)]^{γ}, wherein:

V′_{NL}(x,y)=(V_{NL}(x,y)−Vₘᵢₙ)/(Vₘₐₓ−Vₘᵢₙ),
γ corresponds to a positive coefficient with γ>1, and
β corresponds to a positive coefficient with 0<β<γ, or preferably 0<β≤1.

For instance, the darkening function D_{F} may be expressed as a weighted sum of N≥2 components:

D_{F}(V_{NL}(x,y))=(Σₙ₌₁^{N}αₙ×[V′_{NL}(x,y)]^{δ}^{ₙ})×(Vₘₐₓ−Vₘᵢₙ)+Vₘᵢₙ (1)

wherein δ₁=β, δ_{N}=γ, δₙ<δₙ₊₁ for any 1≤n≤N−1 and:

Σₙ₌₁^{N}αₙ=1

Basically, having a high value for γ increases the contrast for high V channel values, which is positive for the darkening function since it will increase the contrast between strong light sources and the rest of the scene. However, considering only the [⋅]^{γ} component with a high value for γ would imply that the contrast for low V channel values would be near zero, which is not desirable since the shadows would become substantially uniform with no details inside them. Including the component [⋅]^{β} with a low value for β (preferably β=1) therefore ensures some contrast in the low-light HSV image even for portions of the target HSV image which have low V channel values.

In preferred embodiments, the sum Σₙ₌₁^{N}αₙ may be such that

Σₙ₌₁^{N}αₙ=1+ε

with 0<ε≤0.2, for instance ε=0.1. In such a case, for values of [V′_{NL}(x,y)] close to 1, then the weighted sum in equation (1) will exceed Vₘₐₓ, so a further clippling is applied to keep the darkening function D_{F} in the V channel range [Vₘᵢₙ,Vₘₐₓ]. In such a case, the darkening function D_{F} may be given by:

$${D}_{F} ( {V}_{NL} ( x , y ) ) = Min ( {V}_{max} , ( {\sum }_{n = 1}^{N} {α}_{n} \times {[ {V}_{NL}^{′} ( x , y ) ]}^{{δ}_{n}} ) \times ( {V}_{max} - {V}_{min} ) + {V}_{min} )$$

Hence, such a clipping saturates the really bright pixels. This can be beneficial to simulate more realistic night images. Indeed, in real night images or videos, the cameras tend to increase their sensitivity (or ISO setting) to better match the average brightness of the scene. However, this also means that bright light sources are more likely to exceed the dynamic range of the camera, and thus they and their immediate surrounding become saturated at the value Vₘₐₓ. Comparatively, in situations with normal lighting, cameras adopt much lower sensitivities, and thus the light sources are usually not saturated, or at least not their immediate surrounding. Consequently, artificially saturating the light sources in the low-light images may lead to a more realistic training dataset in that aspect and enables training the machine learning model into reducing the saturated areas around light sources.

In exemplary embodiments, N=2 and the darkening function D_{F} is given by:

D_{F}(V_{NL}(x,y))=V_{LL}(x,y)=(α×[V′_{NL}(x,y)]^{β}+(1−α)×[V′_{NL}(x,y)]^{γ})×(Vₘₐₓ−Vₘᵢₙ)+Vₘᵢₙ (2)

wherein α corresponds to a positive coefficient with α<1 (or preferably α≤0.5) and 0<β<γ (or preferably 0<β≤1). Hence, a corresponds to α₁ and (1−α) corresponds to α₂ in equation (1).

For instance, the coefficients α, β and γ in equation (2) (or αₙ and δ₂ in the case of equation (1)) may be the same for all pairs of the training dataset. In preferred embodiments, all or part of the coefficients α, β and γ (or αₙ and δₙ) may vary from one target image/low-light image pair to another. Preferably, when considering image sequence (video) pairs, the same coefficients α, β and γ (or αₙ and δₙ) are used to generate all the images of the low-light image sequence.

For instance, the coefficient β may be the same for all pairs (for instance β=1) and the coefficients α and γ may vary from one target image/low-light image pair to another. Preferably, the coefficients α and γ are selected randomly from one target image/low-light image pair to another, according to predetermined probability distributions, for instance uniform probability distributions. For instance, the coefficient α is selected according to a probability distribution having a mean value in [0.1; 0.3]. For instance, the probability distribution for the coefficient α is a uniform probability distribution defined between [0.1; 0.3], i.e. α˜ [symbol] (0.1,0.3). For instance, the coefficient γ is selected according to a probability distribution having a mean value in [2; 6] or in [3; 5]. For instance, the probability distribution for the coefficient γ is a uniform probability distribution defined between [3; 5], i.e. γ˜ [symbol] (3,5). Alternatively, or in combination thereof, the coefficient β may vary from one target image/low-light image pair to another. For instance, the coefficient β is selected according to a probability distribution having a mean value in [1; 2]. For instance, the probability distribution for the coefficient β is a uniform probability distribution defined between [1; 2], i.e. β˜ [symbol] (1,2).

With or without using one of the enhanced darkening functions discussed above, it is also proposed to set constrains on the target images in order to perform a more realistic low-light image enhancement. Indeed, in some cases, the choice of the target images also influences the capability of producing realistic synthetic (virtual) low-light images, even when using the enhanced darkening functions discussed above.

For instance, if the darkening function is applied on outdoor images taken during the day, then the output images might not look like “real” low-light images. This is due, inter alia, to the shadows and light sources inside the image. The shadows are mostly created by the sun, so they are all in the same direction and they have a sharp transition between light and dark. Also, the light provided by light sources is not strong compared to the sun usually, so they do not create their own strong shadows and the signal close to light sources is not much higher compared to the rest of the sun-lit areas. Even though the average brightness is low after applying a darkening function, the obtained low-light images might not be realistic.

In preferred embodiments, in order to be able to produce more realistic low-light images, the darkening function is applied not on day images but on images taken during twilight. In other words, the target HSV image preferably represents a scene imaged during twilight. In the present disclosure, “twilight” is understood to mean the period of time which includes civil twilight, nautical twilight, and astronomical twilight. Hence, at sunset, the twilight corresponds to the period of time starting when the sun passes fully below the horizon (start of civil twilight) and ending when the sun passes fully below 18° below the horizon (end of astronomical twilight). At dawn, the twilight corresponds to the period of time starting when the sun ceases to be fully below 18° below the horizon (start of astronomical twilight) and ending when the sun ceases to be fully below the horizon (end of civil twilight).

Considering target HSV images representing scenes imaged during twilight removes the strong shadows created by the sun and might also ensure that public lights and vehicles lights are turned on. This ensures that the light sources inside the scene are the main sources of light, so they create their own shadows and are much brighter than the rest of the scene, so when we apply the darkening function, they are almost fully white and we do not reduce their signal, but we reduce the signal for the rest of the scene.

During twilight, the sky acts as a diffuser and provides a uniform illumination of the scene, ensuring that even in regions not lit by the light sources inside the scene, there is a high enough signal and consequently a high enough signal-to-noise ratio. For these reasons also, target images acquired during twilight are good target images to use to train the machine learning model. Also, when acquiring an image sequence (video) using a dedicated low-light mode of e.g. a smartphone, end-users do not want to have an output video which looks like a daylight video. End-users want to see what is inside the shadows and have no noise in the output video, but still have some contrast between light sources and the rest of the scene. This is usually the case in twilight videos, so they are also better target images than daylight videos for they are more representative of the results expected by end-users.

For instance, when generating a pair of the training dataset, the target image may be deliberately acquired during twilight for the purpose of generating such a pair. Alternatively, the target image may be selected among a set of candidate images, by searching said set for a candidate image acquired under twilight conditions. For instance, a candidate image acquired during twilight may be searched for by analyzing metadata of said candidate images. For instance, the metadata may be representative of the acquisition position and acquisition time of each candidate image, which metadata can be used to determine if a candidate image was acquired during twilight. Alternatively, or in combination thereof, it is possible to identify sky pixels in each candidate image (e.g. via color-based segmentation), and to compute a mean illuminance of the sky pixels. The target image may be selected as being a candidate image having a mean illuminance in a predetermined range.

Alternatively, or in combination thereof, when the target image is selected in a set of candidate images, it is possible to also evaluate the signal to noise ratio in each candidate image, and to select the target image as being a candidate image having a signal to noise ratio in a predetermined range.

Alternatively, or in combination thereof, when the target image is selected in a set of candidate images, other criteria may be considered. For instance, it is possible to discard, manually or automatically, candidate images containing too much sky and/or in which artificial sources of light are not turned on and/or in which the lighting is too strong or too weak, etc. For instance, to avoid learning that the sky should be blue, candidate images with a lot of pixels representing the sky should be avoided. The automatic detection of candidate images with too much sky can be done by segmenting the sky pixels based on their color (looking for pixels with a blue hue for instance) and comparing the number of segmented pixels to a predetermined threshold. Candidate images with a lot of pixels representing the sky can be discarded or, alternatively, the segmentation can be used as a mask during the training of the machine learning model. The automatic detection of the candidate images with too much light can be done e.g. by computing the average brightness of each candidate image and comparing the average brightness to a predetermined threshold.

Alternatively, or in combination thereof, it is possible to consider target images representing indoor scenes with preferably a single source of light (artificial or natural) illuminating the indoor scene. Indeed, normal indoor lighting is usually quite uniform, resulting in images without any deep shadows. Thus, when applying the darkening function discussed above, the brightness of the indoor scene might be reduced uniformly, which is not optimal. In preferred embodiments, we consider a target image representing an indoor scene with only one source of light illuminating the indoor scene. This can be done by switching on only one artificial source of light, or by closing all the blinds except one. This creates some shadows in the indoor scene such that, when the darkening function is applied, the resulting scene represented by the low-light image looks more like a real low-light indoor scene.

Of course, in order to train the machine learning model, the training dataset should contain a plurality of target image/low-light image pairs, preferably a large number of target image/low-light image pairs. All or part of the training dataset can be built as discussed in any of the above embodiments, in particular by applying a darkening function on the V channel of target HSV images. In some cases, the training dataset may contain target image/low-light image pairs obtained by other means. For instance, the training dataset may contain real pairs, i.e. pairs in which none of the images is synthetically obtained by modifying the other image. In other words, a real pair comprises images of a same scene acquired (i.e. non synthetic) under respectively normal-light conditions and low-light conditions, with for instance the target image acquired during daytime or twilight and the low-light image acquired during nighttime. Also, the training dataset preferably contains target image/low-light image pairs representing a variety of outdoor and/or indoor scenes, a variety of number of sources of light in the scene, etc., in order to be able to train the machine learning model to handle a variety of different scenarios.

It should be noted that real target image/low-light pairs can also be used to determine a reference darkening function, by comparing the target image and the low-light image of each real pair. Such a reference darkening function can be used during the image processing method 50 to generate a low-light HSV image from a target HSV image. Alternatively, the reference darkening function can be used to determine the parameters αₙ and δₙ in the equation (1) or (2) above which yield a darkening function D_{F} which approximates the reference darkening function, and which is used to generate a low-light HSV image from a target HSV image.

As indicated before, the machine learning model may be trained during a training phase 11 carried out by the training unit 30, via supervised learning. In such a case, the training unit 30 uses the training dataset to train the machine learning model to enable predicting, for each pair, the target image from the low-light image of said each pair.

For instance, during the training phase 11, the machine learning model is iteratively updated for each target image/low-light image pair in order to minimize a predefined loss function, until a predefined stop criterion is satisfied. For each target image/low-light image pair, the loss function compares an image, obtained by processing the low-light image with the machine learning model, with the expected target image. This iterative process is repeated for each target image/low-light image pair of the training dataset. However, the proposed training dataset may be applied with any supervised learning scheme known to the skilled person. According to non-limitative examples, the proposed training dataset may be applied with the supervised learning schemes discussed in [Jiang+2019] and [Lv+2020].

In preferred embodiments, the training dataset is used to train a machine learning model which corresponds to a convolutional neural network (CNN), preferably a fully convolutional neural network (FCN). For instance, the machine learning model includes a U-Net [Ronneberger+2015]. Such a U-Net comprises an encoder which successively down-samples an image (i.e. low-light image during the training phase 11 or input image during the predicting phase 12) and a decoder which successively up-samples back to the original resolution the image received from the encoder. Skip connections between the encoder and the decoder ensure that small details in the input image are not lost. For instance, the machine learning model comprises a lightweight U-net with five convolutional down-sampling layers and five corresponding convolutional up-sampling layers.

More generally speaking, any suitable architecture may be considered for the machine learning model, in particular any suitable CNN architecture, and the training dataset may be used to train any type of machine learning model suitable for low-light image enhancement processing. According to non-limitative examples, the training dataset may be used to train the machine learning models discussed in [Jiang+2019] and [Lv+2020].

We now discuss an image processing method 70 for enhancing illumination of an input image representing a scene. This illumination enhancement image processing method 70 is carried out during the predicting phase 12, by the correcting unit 40, by using a previously trained machine learning model. In preferred embodiments, this machine learning model is previously trained by using the training dataset discussed above.

The illumination enhancement image processing method 70 discussed hereinbelow can be implemented with limited computational complexity, and may be used even by devices having constrained computational and data storage capabilities, for instance mobile devices such as mobile phones, tablets, digital cameras, etc.

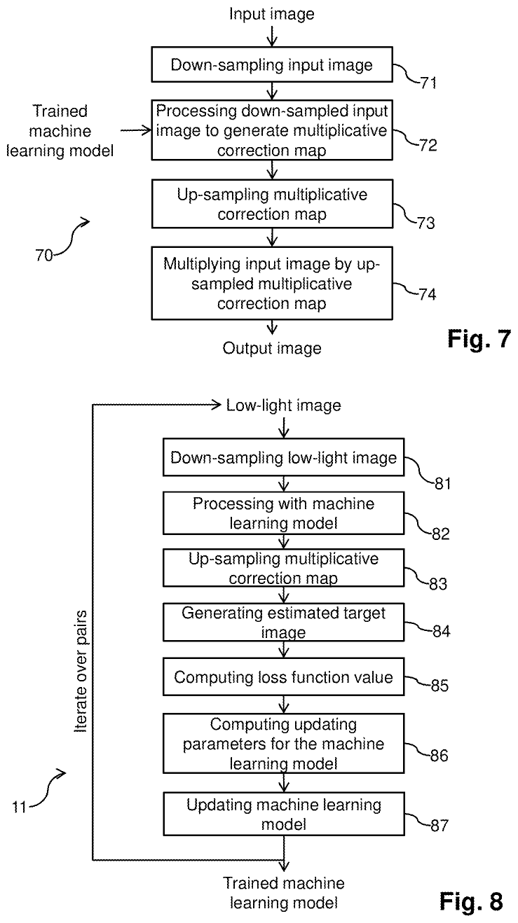

FIG. 7 represents schematically the main steps of an image processing method 70 for enhancing the illumination of an input image representing a scene, based on a previously trained machine learning model, which are carried out by the correcting unit 40.

As illustrated by FIG. 7, the illumination enhancement image processing method 70 comprises a step 71 of down-sampling an input image, which produces a down-sampled input image having a lower resolution than the original input image. In the sequel, the input image is denoted IN and is assumed in a non-limitative manner to have a size W× H× Ch, wherein:
W corresponds to a number of pixels along a width dimension of the input image,
H corresponds to a number of pixels along a height dimension of the input image,
Ch corresponds to a number of color channels of the processing color space; typically, Ch=3 and the color channels may correspond e.g. to the red-green-blue (RGB) channels.

The input image IN is therefore composed of W×H pixels, and the value IN(x,y) of a given pixel (x,y) (with 1≤x≤W and 1≤y≤H) corresponds to a vector of size Ch representing e.g. an RGB triplet.

The down-sampled input image IN′ obtained after the down-sampling step 71 has a size W′×H′×Ch, with W′<W and H′<H. The down-sampled input image IN′ is therefore composed of W′×H′ pixels, and the value IN′(x′, y′) of a given pixel (x′, y′) (with 1<x′<W′ and 1<y′<H′) corresponds to a vector of size Ch representing e.g. an RGB triplet if the pixels on the input image IN are RGB triplets. The step 71 may use any down-sampling method known to the skilled person, and the choice of a specific down-sampling method corresponds to a specific non-limitative embodiment of the present disclosure. For instance, the down-sampling of the input image is performed using an area resizing method.

As illustrated by FIG. 7, the illumination enhancement image processing method 70 comprises a step 72 of processing the down-sampled input image IN′ with the trained machine learning model. The machine learning model is previously trained to generate a multiplicative correction map denoted CM′. For instance, said multiplicative correction map CM′ has a size W′× H′× Ch and is composed of W′×H′ multiplicative correction factors. Each multiplicative correction factor CM′(x′, y′) corresponds to a vector of size Ch to be applied to the pixel (x′,y′) of the down-sampled input image IN′ for enhancing the illumination of said down-sampled input image IN′.

As illustrated by FIG. 7, the illumination enhancement image processing method 70 comprises a step 73 of up-sampling the multiplicative correction map CM′, which produces an up-sampled multiplicative correction map CM having a higher resolution than the multiplicative correction map CM′. For instance, the up-sampled multiplicative correction map CM has the same resolution as the original input image IN, in which case the up-sampled multiplicative correction map CM has a size W× H× Ch and is composed of W×H up-sampled multiplicative correction factors. Each up-sampled multiplicative correction factor CM(x,y) corresponds to a vector of size Ch to be applied to the pixel (x,y) of the input image IN for enhancing the illumination of said input image IN. The step 73 may use any up-sampling method known to the skilled person, and the choice of a specific up-sampling method corresponds to a specific non-limitative embodiment of the present disclosure. For instance, the up-sampling of the multiplicative correction map is performed using bilinear, bicubic resampling or by guided up-sampling using the input image IN as guide image.

As illustrated by FIG. 7, the illumination enhancement image processing method 70 comprises a step 74 of generating an output image OUT by multiplying the input image IN by the up-sampled multiplicative correction map CM:

OUT(x,y)=CM(x,y)×IN(x,y)

Assuming that IN(x,y) corresponds to an RGB triplet (IN_{R}(x,y), IN_{G}(x,y), IN_{B}(x,y)) and that CM(x,y) corresponds to an RGB triplet (CM_{R} (x,y), CM_{G} (x,y), CM_{B} (x,y)) and that OUT (x,y) corresponds to an RGB triplet (OUT_{R}(x,y), OUT_{S}(x,y), OUT_{B}(x,y)), then:

OUT_{R}(x,y)=CM_{R}(x,y)×IN_{R}(x,y)

OUT_{G}(x,y)=CM_{G}(x,y)×IN_{G}(x,y)

OUT_{B}(x,y)=CM_{B}(x,y)×IN_{B}(x,y)

Of course, other processing color spaces than the RGB color space can be considered. For instance, the HSV color space may be considered instead as the processing color space and, if only the brightness is to be corrected, it is possible to consider scalar multiplicative correction factors to be applied on the V channel only.

Hence, the illumination enhancement image processing method 70 combines lower resolution processing (by applying the trained machine learning model to a down-sampled input image IN′) with multiplicative correction. By performing many operations at a lower resolution than the resolution of the input image, the computational complexity and memory footprint of the machine learning model is reduced compared to using the same resolution as the input image. Hence, the machine learning model may be used even by devices having constrained computational and data storage capabilities, for instance mobile devices such as mobile phones, tablets, digital cameras, etc. Also, thanks to the multiplicative correction, details are preserved even though the machine learning model runs in low resolution. This is because using a multiplicative correction preserves the contrast of the small details of the image. There is no need for a multiplicative correction map to contain small details, only a multiplicative correction factor to apply in a wide area. The multiplicative correction factor can be the same within a given shadow for instance, so the multiplicative correction map does not need to be high-resolution. Then, the multiplicative correction ensures that the contrast is at least preserved, as explained below.

Known machine learning models for illumination enhancement rely on additive correction. However, additive correction requires to process the input image at full resolution, or else it will not preserve the contrast of small details. For instance, if we consider a given shadow in the input image, then if additive correction is used in low resolution, all the additive correction factors will have substantially a same value K within the shadow. If the additive correction map is up-sampled and added to the input image, then the variations in the shadow will have much less contrast, as explained below.

The definition of the local contrast in the shadow is given:

$$Contrast = 2 \times \frac{LocalMax - LocalMin}{LocalMax + LocalMin}$$

wherein LocalMax is the local maximum value and LocalMin is the local minimum value. After adding the additive correction map to the input image, the local contrast in the shadow becomes:

$$\begin{matrix}Contrast = 2 \times \frac{K + LocalMax - ( K + LocalMin )}{K + LocalMax + K + LocalMin} \\ = 2 \times \frac{LocalMax - LocalMin}{2 \times K + LocalMax + LocalMin}\end{matrix}$$

In the case of a shadow, K might be large such that the local contrast tends to 0. In other words, the contrast is lost so it is clearly not suited for enlightening dark input images, hence the need to predict additive corrections in full resolution (to ensure that the additive correction factor is not the same for LocalMax and LocalMin).

When considering multiplicative correction, all the multiplicative correction factors will similarly have substantially a same value K′ within the shadow. After multiplying by the multiplicative correction map, the local contrast becomes:

$$Contrast = 2 \times \frac{{K}^{′} \times LocalMax - ( {K}^{′} \times LocalMin )}{{K}^{′} \times LocalMax + {K}^{′} \times LocalMin} = 2 \times \frac{LocalMax - LocalMin}{LocalMax + LocalMin}$$

Hence, the local contrast is the same as in the input image, meaning that the contrast is preserved. Consequently, the low-resolution multiplicative correction approach is computationally less expensive (and hence yields better results in less time) and preserves contrast. It should be noted that the low-resolution multiplicative correction approach may not be suited to removing noise, because noise consists in small structures. The use of the low-resolution multiplicative correction approach is therefore specifically suited to the problem of correcting the illumination (light intensity and color) in an image, and not for a more complex processing performing simultaneously illumination correction and noise removal. However, in most devices having to perform illumination enhancement, noise removal is usually performed by a dedicated hardware resource in the camera imaging pipeline, such that it can be assumed that the input images of the illumination enhancement image processing method 70 have been previously denoised by existing and widespread resources. It also makes the integration in the imaging pipeline significantly easier as the present illumination enhancement image processing method 70 can be added at the end of the imaging pipeline. Additionally, down-sampling the input images further reduces the noise and makes the illumination enhancement image processing method 70 more robust to any remaining noise.

The illumination enhancement image processing method 70 may use any suitable architecture for the machine learning model. In preferred embodiments, the machine learning model corresponds to a CNN, preferably an FCN. For instance, the machine learning model includes a U-Net [Ronneberger+2015], such as a lightweight U-net with five convolutional down-sampling layers and five corresponding convolutional up-sampling layers. In some cases, the U-net may optionally use an attention mechanism to focus on darker areas (shadows) of the down-sampled input image.

Due to the fact that a multiplicative correction is applied, some of the pixels of the input image may need to be addressed specifically.

This is for instance the case of saturated pixels of the input image. Basically, the color channel values of a pixel are typically defined in respective color channel ranges, each color channel range having a respective minimum value and a respective maximum value. For instance, with 8 bits in the RGB color space, the color channel range may be for instance between 0 (minimum value) and 255 (maximum value). A saturated pixel corresponds to a pixel having at least one color channel value equal to its possible maximum value.

After applying the up-sampled multiplicative correction map, the color channel values of the pixels of the output image need to also fit in the same color channel ranges. Applying a strong multiplicative factor then clipping pixels which were already saturated in the input image can result in color artefacts. In preferred embodiments, for saturated pixels of the input image, the corresponding up-sampled multiplicative correction factor is not applied, and each saturated pixel of the input image is directly copied in the output image. In other words:
OUT(x,y)=CM(x,y)×IN(x,y) only for non-saturated pixels of the input image IN, and
OUT(x,y)=IN(x,y) for saturated pixels of the input image IN.

It should be noted that the same processing can also be applied for pixels which are not saturated in the input image but are saturated after applying the multiplicative correction factor. However, the inventors have noticed that, through training, the machine learning model usually learned to predict multiplicative correction factors which avoided saturating pixels.

Pixels that have a value of 0 in one of their color channels in the input image are also a case which may need to be addressed specifically. Because of the multiplicative nature of the correction, this color channel will also have a value 0 in the output image no matter the multiplicative correction factor applied. This can also lead to color artefacts. A possible optional way to avoid this is to preprocess the input image before applying the up-sampled multiplicative correction map. For instance, the preprocessing may consist in adding a constant positive offset value E to each color channel of each pixel of the input image before multiplying by the up-sampled multiplicative correction map. The offset value E can possibly vary from one color channel to another but is preferably the same for all pixels of the input image. Of course, the offset value is preferably small, for instance equal to the smallest possible non-zero value for each color channel. Thanks to this offset value E, the pixel of the input image after preprocessing can no longer have a color channel with a value 0. Hence, pixels of the output image OUT are obtained as follows:

OUT(x,y)=CM(x,y)×(IN(x,y)+ε)

In some embodiments, this preprocessing may also be applied before applying the machine learning model. In this case, the machine learning model processes the image (IN+ε) and produces a multiplicative correction map CM′, and the output image OUT is obtained as:

OUT(x,y)=CM′(x,y)×(IN(x,y)+ε)

If it is determined that the pixel value (IN(x,y)+E) is saturated, then the multiplicative correction factor is preferably not applied and OUT(x,y)=(IN(x,y)+ε) (with possibly (IN(x,y)+ε) clipped to the maximum possible value). Also, if it is determined that the pixel value/N(x,y) is saturated, the constant offset ε and the multiplicative correction factor are preferably not applied and OUT(x,y)=IN(x,y) for this pixel.

FIG. 8 represents schematically the main steps of an exemplary embodiment of the training phase 11, carried out by the training unit 30, for training the machine learning model used by the illumination enhancement image processing method 70. In this non-limitative example, the training phase 11 uses a training dataset containing target image/low-light image pairs, for instance generated as discussed hereinabove.

As illustrated by FIG. 8, the training phase 11 comprises a step 81 of down-sampling a low-light image, denoted LL, for instance composed of W×H pixels, which generates a down-sampled low-light image, denoted LL′, composed of W′×H′ pixels. Then the down-sampled input image LL′ is processed by the machine learning model during a step 82, which provides an estimated multiplicative correction map, denoted [symbol] , composed of W′× H′ estimated multiplicative correction factors [symbol] (x,y). The estimated multiplicative correction map [symbol] is then up-sampled during a step 83, which produces an estimated up-sampled multiplicative correction map, denoted [symbol] . Then the training phase 11 comprises a step 84 of generating an estimated target image, denoted [symbol] , by multiplying the estimated up-sampled multiplicative correction map [symbol] to the low-light image LL:

[symbol]

(x,y)= [symbol] (x,y)×LL(x,y)

As illustrated by FIG. 8, the training phase 11 comprises a step 85 of computing the value of the loss function value based on the target image NL associated to the low-light image LL of the considered pair and based on the estimated target image [symbol] . Basically, the loss function value compares the target image NL with the estimated target image [symbol] and is minimal when the target image NL and the estimated target image [symbol] are identical.

The training phase 11 comprises a step 86 of computing updating parameters for the machine learning model. Indeed, the machine learning model (e.g. CNN) is defined by a set of parameters, and the training phase 11 aims at identifying optimal values for this set of parameters, i.e. values of the set of parameters which optimize the loss function. The updating parameters are therefore modifications to the set of parameters which, in principle, should cause the machine learning model to generate estimated target images which further reduce the loss function value. Such updating parameters may be determined in a conventional manner by e.g. gradient descent methods.

The training phase 11 comprises a step 87 of updating the set of parameters of the machine learning model based on the updating parameters.

As illustrated by FIG. 8, the steps 81, 82, 83, 84, 85, 86 and 87 are iterated over pairs of the training dataset, until a predefined stop criterion is satisfied. When all the considered pairs have been processed, the training phase 11 may stop, and the machine learning model obtained when the stop criterion is satisfied corresponds to the trained machine learning model used by the correcting unit 40 to enhance illumination of input images during the predicting phase 12.

According to a non-limitative example, the loss function may comprise an evaluation of a sum of pixelwise distances between the estimated target image [symbol] and the target image NL. For instance, the distance considered may be based on a p-norm, preferably a 2-norm (a.k.a. L2 norm), between the pixels' values. The loss function may for instance be expressed as:

$$loss = {\sum }_{x = 1}^{W} {\sum }_{y = 1}^{H} {‖ ( x , y ) - NL ( x , y ) ‖}_{2}^{2}$$

wherein ∥⋅∥₂ is the 2-norm.

Of course, other loss functions may be used during the training phase 11. Also, other supervised learning methods may be used to train the machine learning model to predict relevant multiplicative correction maps, and the choice of a specific supervised learning method corresponds to a specific non-limitative embodiment of the present disclosure.

It is emphasized that the present disclosure is not limited to the above exemplary embodiments. Variants of the above exemplary embodiments are also within the scope of the present invention.

### REFERENCES

[Jiang+2019] Jiang Haiyang and Zheng Yinqiang: “Learning to see moving objects in the dark”, in Proceedings of the IEEE/CVF International Conference on Computer Vision, 2019, pages 7324-7333
[Lv+2020] Lv Feifan, Li Yu and Lu Feng: “Attention guided low-light image enhancement with a large scale low-light simulation dataset”, ArXiv:1908.00682, 2020, https://arxiv.org/abs/1908.00682
[Ronneberger+2015] Olaf Ronneberger, Philipp Fischer and Thomas Brox: “U-Net: Convolutional Networks for Biomedical Image Segmentation”, International Conference on Medical image computing and computer-assisted intervention, Springer, Cham, 2015. pp. 234-241, arXiv:1505.04597

1. An image processing method for enhancing illumination in an input image representing a scene, said image processing method comprising:
down-sampling the input image,
processing the down-sampled input image with a machine learning model, wherein said machine learning model is previously trained to generate a multiplicative correction map, said multiplicative correction map comprising multiplicative correcting factors for enhancing the illumination of the down-sampled input image,
up-sampling the multiplicative correction map,
generating an output image by multiplying the input image by the up-sampled multiplicative correction map.

2. The image processing method of claim 1, wherein the machine learning model is a convolutional neural network.

3. The image processing method of claim 1, wherein the machine learning model comprises a U-Net.

4. The image processing method of claim 1,
wherein the input image comprises pixels, each pixel comprising color channel values in respective color channel ranges, each color channel range comprising a respective maximum value,
wherein, responsive to identifying a saturated pixel of the input image for which a color channel value is equal to the maximum value of the corresponding color channel range: copying the saturated pixel in the output image without applying the up-sampled multiplicative correction map to said saturated pixel.

5. The image processing method of claim 1, comprising adding an offset value to pixels of the input image before multiplying the input image by the up-sampled multiplicative correction map values to generate the output image.

6. The image processing method of claim 5,
wherein each pixel of the input image comprises color channel values in respective color channel ranges, each color channel range comprising a respective maximum value,
wherein, responsive to identifying a saturated pixel of the input image obtained after adding the offset value for which a color channel value is equal to the maximum value of the corresponding color channel range: copying the saturated pixel in the output image without applying the up-sampled multiplicative correction map to said saturated pixel.

7. The image processing method of claim 5,
wherein each pixel of the input image comprises color channel values in respective color channel ranges, each color channel range comprising a respective maximum value,
wherein, responsive to identifying a saturated pixel of the input image before adding the offset value for which a color channel value is equal to the maximum value of the corresponding color channel range: copying the saturated pixel in the output image without adding the offset value and without applying the up-sampled multiplicative correction map to said saturated pixel.

8. An image processing system for enhancing illumination in an input image representing a scene, said image processing system comprising a correcting unit comprising at least one memory and at least one processor, wherein said at least one processor of the correcting unit is configured to:
down-sample the input image,
process the down-sampled input image with a machine learning model, wherein said machine learning model is previously trained to generate a multiplicative correction map, said multiplicative correction map comprising multiplicative correcting factors for enhancing the illumination of the down-sampled input image,
up-sample the multiplicative correction map,
generate an output image by multiplying the input image by the up-sampled multiplicative correction map.

9. The image processing system of claim 8, wherein the machine learning model is a convolutional neural network.

10. The image processing system of claim 8, wherein the machine learning model comprises a U-Net.

11. The image processing system of claim 8,
wherein the input image comprises pixels, each pixel comprising color channel values in respective color channel ranges, each color channel range comprising a respective maximum value,
wherein the at least one processor of the correcting unit is further configured to, responsive to identifying a saturated pixel of the input image for which a color channel value is equal to the maximum value of the corresponding color channel range: copy the saturated pixel in the output image without applying the up-sampled multiplicative correction map to said saturated pixel.

12. The image processing system of claim 8, wherein the at least one processor of the correcting unit is further configured to add an offset value to pixels of the input image before multiplying the input image by the up-sampled multiplicative correction map values to generate the output image.

13. The image processing system of claim 12,
wherein each pixel of the input image comprises color channel values in respective color channel ranges, each color channel range comprising a respective maximum value,
wherein the at least one processor of the correcting unit is further configured to, responsive to identifying a saturated pixel of the input image obtained after adding the offset value for which a color channel value is equal to the maximum value of the corresponding color channel range: copy the saturated pixel in the output image without applying the up-sampled multiplicative correction map to said saturated pixel.

14. The image processing system of claim 12,
wherein each pixel of the input image comprises color channel values in respective color channel ranges, each color channel range comprising a respective maximum value,
wherein the at least one processor of the correcting unit is further configured to, responsive to identifying a saturated pixel of the input image before adding the offset value for which a color channel value is equal to the maximum value of the corresponding color channel range: copy the saturated pixel in the output image without adding the offset value and without applying the up-sampled multiplicative correction map to said saturated pixel.

15. A non-transitory computer readable medium comprising computer readable code which, when executed by one or more processors, cause said one or more processors to enhance illumination in an input image representing a scene by:
down-sampling the input image,
processing the down-sampled input image with a machine learning model, wherein said machine learning model is previously trained to generate a multiplicative correction map, said multiplicative correction map comprising multiplicative correcting factors for enhancing the illumination of the down-sampled input image,
up-sampling the multiplicative correction map,
generating an output image by multiplying the input image by the up-sampled multiplicative correction map.
